(19) United States
(12) Patent Application Publication
(10) Pub. No.: US 2007/0264049 A1
(43) Pub. Date: Nov. 15, 2007

(54) Image Forming Apparatus

(75) Inventors: Shinichi KAMOSHIDA, Shiojiri-shi (JP); Masaru Kobashi, Matsumoto-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION

(21) Appl. No.: 11/746,523

(22) Filed: May 9, 2007

(30) Foreign Application Priority Data
May 10, 2006 (JP) 2006-131074
Mar. 28, 2007 (JP) 2007-083491

(51) Int. Cl. G03G 15/02; G03G 21/00

(52) U.S. Cl. 399/168; 399/350

(57) ABSTRACT

An image forming apparatus includes an image carrying member; a charge unit charges the image carrying member in a non-contact manner using a charge roller; a development unit develops the electrostatic latent images on the image carrying member; a transfer unit transfers the developer images on the image carrying member onto a transfer medium; a cleaning unit removes a transfer-residual developer remaining on the image carrying medium after the developer images are transferred onto the transfer medium; a first and a second gap member are fixed onto one and an other end of the charge roller and pressed onto outer peripheral surface of the image carrying member, thereby forming charging gaps; discharge dead zones are provided, the cleaning blade is disposed such that the ends of the cleaning blade are positioned outside of the inner edges of the first and second gap members.

### BACKGROUND

1. Technical Field

The present invention relates to an image forming apparatus (for example, an electrostatic copying machine, a printer, and a facsimile machine) which includes a charge roller for charging an image carrying member in a non-contact manner by forming a predetermined charge gap relative to the image carrying member using gap members disposed at both end portions of a charging section (or discharging section), and a cleaning blade for making contact with the image carrying member in order to clean the surface of the image carrying member.

2. Related Art

A known example of an image forming apparatus is one which includes a charge roller for charging an image carrying member in a non-contact manner with a predetermined charge gap relative to the image carrying member, and a cleaning blade for removing dirty materials such as toner particles remaining on the image carrying member after a transfer process and thus cleaning the image carrying member (see JP-A-2001-296723, for example). As shown in FIG. 6, the charge roller a used in the image forming apparatus disclosed in JP-A-2001-296723 is configured such that a discharging section having a resistor layer c made of a conductive elastic member formed on the peripheral surfaces of a metal core b is prepared in the charger roller a, and a pair of gap members d and e made of a taper-shaped insulating film are wound into a ring shape and fixed onto the peripheral surfaces at both ends of the resistor layer c. When the pair of gap members d and e are brought into contact with the peripheral surface of a photosensitive drum f as the image carrying member, a predetermined charging gap G is formed between the photosensitive drum f and a charging section a₁ of the charge roller a (here, the charging section a₁ corresponds to the portion of the resistor layer c between the pair of gap members d and e). In such a case, the discharging section is formed by the charging section al of the charge roller a between the pair of gap members d and e, and the portion a₂ and a₃ of the resistor layer c between the gap members d and e and both ends of the charge roller a.

When bearings i and j of rotation shafts g and h protruding from both sides of the metal core b in the same axial directions are pressed toward the photosensitive drum f by a biasing force of pressure springs k and m, the gap members d and e are brought into contact with the peripheral surface of the photosensitive drum f. A cleaning member n is in contact with the surfaces of the gap members d and e and the surface of the charging section a₁ of the charge roller a. Thus, toner particles or dirty materials adhered onto the peripheral surface of the charge roller a including the pair of gap members d and e can be removed by the cleaning member n. In this case, the charging gap G is maintained at a predetermined value by the pair of gap members d and e. A cleaning blade o made, for example, of an elastic material is in contact with the surface of the photosensitive drum f. Thus, dirty materials such as toner particles remaining on the photosensitive drum f after a transfer process can be removed by the cleaning blade o.

The charging section a₁ of the charge roller a charges the photosensitive drum f in a non-contact manner with the charging gap G relative to the photosensitive drum f. Therefore, it is possible to suppress generation of ozone during such a charging operation, and prevent dirty materials such as toner particles on the photosensitive drum t from adhering onto the charge roller a, or prevent constituent materials contained in the resistor layer c of the charge roller a from adhering onto the photosensitive drum f. Accordingly, it is possible to improve the charging capability of the charge roller a charging the photosensitive drum f. Since dirty materials such as toner particles adhered onto the surface of the charging section a₁ of the charge roller a and the surfaces of the gap members d and e can be removed by the cleaning member n, the charging capability of the charging section a₁ can be maintained at a relatively good level for a relatively long period. Moreover, the charging gap G established by the pair of gap members d and e can be maintained in a stable and precise manner.

Since dirty materials such as toner particles remaining on the photosensitive drum f after a transfer process can be removed by the cleaning blade o, it is possible to display high-quality images for a relatively long period.

However, such a non-contact type charging process requires a relatively high charging voltage to be applied to the charge roller a. Therefore, as the number of printing operations (i.e., the number of printing pages) increases, the ion particles produced in the course of the charging operation collide and energize the surface of the photosensitive drum f and thus increases the frictional coefficient of the surface. Meanwhile, whenever the printing operation is performed, a predetermined amount of toner particles adheres onto an image forming portion (toner-image forming portion) on the surface of the photosensitive drum f. Since the surface of the photosensitive drum f is gradually chipped away as the number of printing operations (i.e., the number of printing pages) increases, the frictional coefficient of the image forming portion on the surface of the photosensitive drum f does not increase. Therefore, on the surface of the photosensitive drum f, there are formed discharge dead zones to which the charging operation is performed but toner particles do not adhere. As shown in FIG. 6, the discharge dead zones are formed in areas f₁ and f₂ on the surface of the photosensitive drum f opposite portions a₄ and a₅ of the discharging section in the charging section a1 of the charge roller a (here, the portions a₄ and a₅ do not contribute to the printing operation). The discharge dead zones are also formed at areas f₃ and f₄ on the surface of the photosensitive drum f opposite portions a₂ and a₃ of the resistor layer c between the gap members d and e and the ends of the charge roller a. In the discharge dead zones f₁, f₂, f₃ and f₄, the respective frictional coefficient of the zones on the surface of the photosensitive drum f are increased as the number of printing operations (i.e., the number of printing pages) increases.

In the case of performing a development process in a non-contact manner in accordance with the non-contact type charging process, if the ends of the cleaning blade o are present on the discharge dead zones on the surface of the photosensitive drum f, the cleaning blade o is likely to bend inward from the ends thereof as the number of printing operations (i.e., the number of printing pages) increases. In particular, such a bending tendency of the cleaning blade o becomes prominent in certain environmental conditions such as a relatively high temperature or a high humidity.

JP-A-2001-296723 discloses a configuration in which the ends of the cleaning blade o are positioned on the surface of the photosensitive drum f opposite the pair of gap members d and e. However, since the discharge dead zones f₁, f₂, f₃ and f₄ are present at both sides of the pair of gap members d and e, the ends of the cleaning blade o are easily influenced by their neighboring discharge dead zones f₁, f₂, f₃ and f₄ and the cleaning blade bends.

### SUMMARY

An advantage of some aspects of the invention is that it provides an image forming apparatus capable of preventing bending of a cleaning blade for cleaning an image carrying member and displaying high-quality images for a relatively long period in a stable manner even when a charging operation is performed in a non-contact manner with a charging gap established by gap members fixed onto both ends of a charge roller.

In the invention, first and second gap members are fixed onto a charge roller so that the outer edges of the first and second gap members are corresponding in position to corresponding edges of the charge roller. With such a configuration, it is possible to prevent discharge dead zones to which the charging operation is performed but toner particles do not adhere from being formed at a position are not likely from generating at areas positioned outside of the outer edges of the first and second gap member. Accordingly, it is possible to restrict the formation areas of the discharge dead zones to those areas positioned inside of the inner edges of the first and second gap members.

Incidentally, the cleaning blade is disposed such that both ends of the cleaning blade are respectively positioned outside of the inner edges of the first and second gap members. Therefore, it is possible to position the ends of the cleaning blade at. positions other than the discharge dead zones. With such a configuration, since the ends of the cleaning blade can be positioned on stabilized non-discharge areas of the image carrying member having smaller frictional coefficient than that of the discharge dead zones, it is possible to prevent the cleaning blade from bending. Accordingly, it is thus possible to maintain a stable printing operation for a long period.

Incidentally, since the bending of the cleaning blade can be prevented, the width of the discharge dead zones formed inside of the inner edges of the first and second gap members needs not be further decreased by that extent but can be suitably set. Therefore, it is possible to suppress adhering of toner particles onto the first and second gap members, which may occur when the width of the discharge dead zones is decreased. Incidentally, since the ends of the cleaning blade are positioned on the non-discharge areas of the image carrying member, it is possible to remove the transfer-residual developer remaining on the image carrying member in a secured manner. Accordingly, it is possible to suppress the developer from adhering onto the gap members.

With such a configuration, it is possible to maintain a stable printing operation for a long period while maintaining a constant charging gap in a stable manner for a relatively long period.

In the invention, axial lengths between the ends of the cleaning blade and corresponding inner edges of the first and second gap members are set so as to be larger than axial lengths of the discharge dead zones. With such a positional relationship between the discharge dead zones and the cleaning blade, it is possible to prevent the bending of the cleaning blade even after operating the image forming apparatus 1 for a long period. In this way, according to the image forming apparatus of the invention it is possible to prolong the lifetime of the cleaning blade and improve stability of an overall process.

### BRIEF DESCRIPTION OF THE DRAWINGS

The invention will be described with reference to the accompanying drawings, wherein like numbers reference like elements.

FIG. 1 is a partial schematic diagram showing a configuration of an image forming apparatus in accordance with a first exemplary embodiment of the invention.

FIG. 2 is a schematic diagram showing configurations of a photosensitive member, a charge roller, and a cleaning member of the charge roller, used in the image forming apparatus shown in FIG. 1.

FIG. 3 is an explanatory diagram showing relationship between axial lengths and positions of the photosensitive member, charge roller, development roller, and cleaning blade, used in the image forming apparatus shown in FIG. 1.

FIG. 4 is a schematic diagram showing configurations of a photosensitive member, a charge roller, and a cleaning member of the charge roller, used in an image forming apparatus in accordance with a second exemplary embodiment of the invention.

FIG. 5 is a schematic diagram showing configurations of a photosensitive member, a charge roller, and a cleaning member of the charge roller, used in an image forming apparatus in accordance with a third exemplary embodiment of the invention.

FIG. 6 is a schematic diagram showing configurations of a photosensitive member and a charge roller, used in an image forming apparatus known in the art.

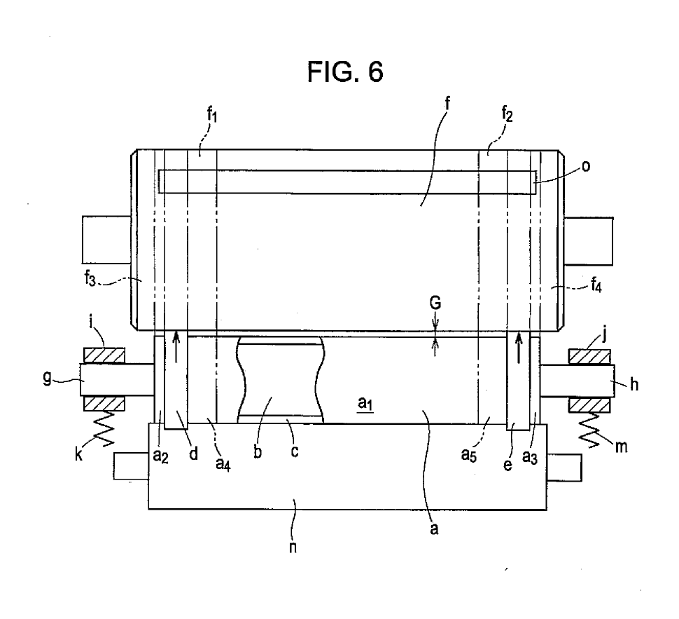

### DESCRIPTION OF EXEMPLARY EMBODIMENTS

Hereinafter, exemplary embodiments of the invention will be described with reference to the accompanying drawings.

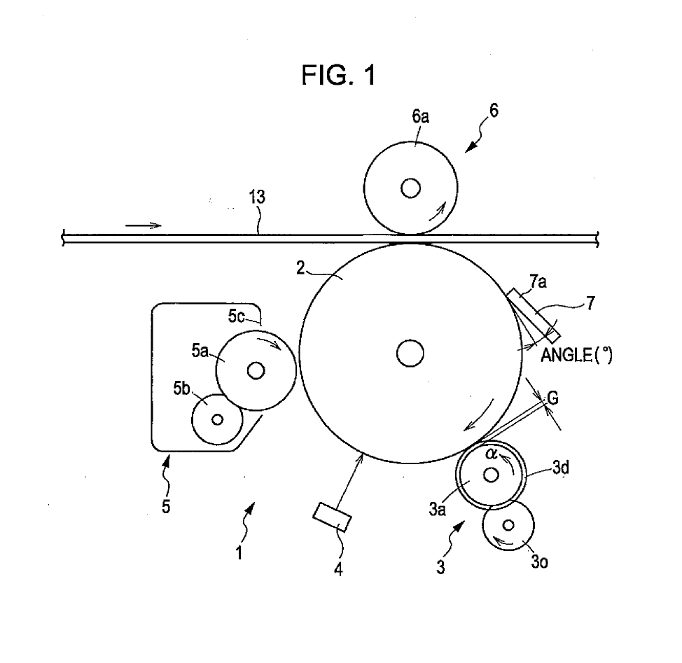

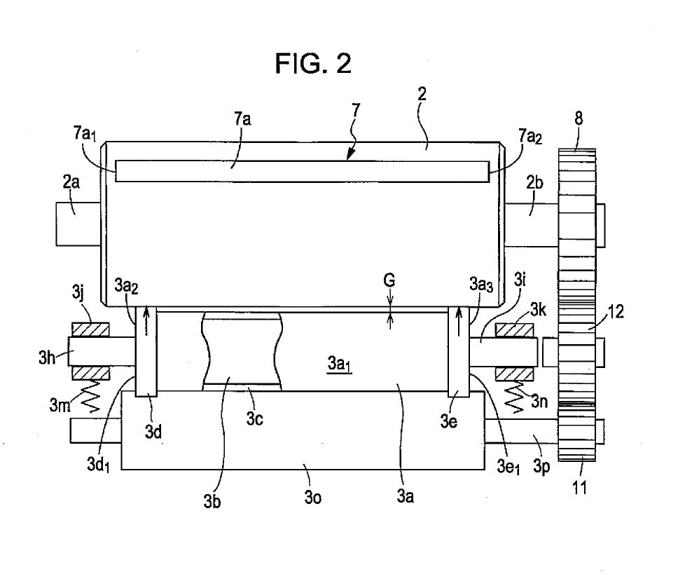

FIG. 1 is a partial schematic diagram showing a configuration of an image forming apparatus in accordance with a first exemplary embodiment of the invention. FIG. 2 is a schematic diagram showing configurations of a photosensitive member, a charge roller, and a cleaning member of the charge roller, used in the image forming apparatus shown in FIG. 1.

As shown in FIGS. 1 and 2, an image forming apparatus 1 of the first exemplary embodiment of the invention includes a photosensitive member 2 as an image carrying member having electrostatic latent images and toner images (developer images) formed thereon. The photosensitive member 2 rotates in the clockwise direction as depicted in FIG. 1. Around the photosensitive member 2, a charge unit 3 for charging the photosensitive member 2 in a non-contact manner, an optical write unit 4 for writing the electrostatic latent images onto the photosensitive member 2, a development unit 5 for developing the electrostatic latent images on the photosensitive member 2 to form toner images on the photosensitive member 2, a transfer unit 6 for transferring the toner images on the photosensitive member 2, and a cleaning unit 7 for cleaning the photosensitive member 2 are disposed in this order from the upstream side in the rotation direction of the photosensitive member 2.

In the present embodiment, the photosensitive member 2 is configured as a photosensitive drum, in which a photosensitive layer having a predetermined thickness is formed on the peripheral surface of a cylindrical metal tube as in the case of the known photosensitive drum. In the photosensitive member 2, a conductive tube such as an aluminum tube is used as the metal tube, and an organic photosensitive material known in the art is used as a material of the photosensitive layer. Incidentally, rotation shafts 2a and 2b protrude from both sides of the photosensitive member 2 in the same axial directions so that the rotation shafts 2a and 2b are rotatably supported on a main device body (not shown) by bearings.

The charge unit 3 includes a charge roller 3a for charging the photosensitive member 2 in a non-contact manner, and the charge roller 3a rotates in a rotation direction a (counter-clockwise direction in FIG. 1) opposite to the rotation direction of the photosensitive member 2. As shown in FIG. 2, the charge roller 3a includes a metal core 3b, and the metal core 3b is configured as a conductive shaft such as a metal shaft. As a conductive shaft, existing products such as “SUM 22” (a product code) having their surface subjected to a Ni-plating treatment may be used.

On the peripheral surfaces of the metal core 3b, a resistor layer 3c is formed by spray-coating a conductive coating material on the peripheral surfaces. Around the peripheral surfaces at both ends of the resistor layer 3c, first and second gap members 3d and 3e made of an insulating film such as an adhesive tape having a predetermined width and a predetermined thickness are wound into a ring shape and fixed onto the peripheral surfaces. In this case, as shown in FIG. 2, outer edges 3d₁ and 3e₁ of the first and second gap members 3d and 3e correspond respectively to the ends 3a₂ and 3a₃ of the charge roller 3a (i.e., the ends of the metal core 3b or the resistor layer 3c).

The charge roller 3a includes rotation shafts 3h and 3i protruding from the sides of the metal core 3b in the same axial directions, and the rotation shafts 3h and 3j are rotatably supported on bearings 3j and 3k, respectively. Similar to the case of the above-described known technology, when the charge roller 3a is pressed toward the photosensitive member 2 by the load of pressure springs 3m and 3n applied through the bearings 3j and 3k of the rotation shafts 3h and 3i of the charge roller 3a, the first and second gap members 3d and 3e are brought into contact with the peripheral surface of the photosensitive member 2. Accordingly, a predetermined charging gap G corresponding to the thickness of the film constituting the gap members 3d and 3e is formed between the resistor layer 3c and the photosensitive member 2.

The charge unit 3 includes a cleaning member 3o configured, for example, as a roller that cleans the charge roller 3a. The cleaning member 3o rotates in a direction (counter-clockwise direction in FIG. 1) opposite to the rotation direction a of the charge roller 3a. In this case, the rotation speed of the cleaning member 3o is set smaller than the rotation speed of the charge roller 3a.

The cleaning member 3o is made of tube-like sponge, and configured such that the sponge makes contact with the peripheral surface of the charge roller 3a including the first and second gap members 3d and 3e with a predetermined pressing force. In such a charge unit 3, the photosensitive member 2 is regularly charged by the charge roller 3a in a non-contact manner with the charging gap G, and the charge roller 3a is cleaned with the cleaning member 3o, whereby dirty materials such as toner particles or dust adhered onto the charge roller 3a are removed.

In FIG. 2, on the right side of the photosensitive member 2, a photosensitive member drive gear 8 for rotating and driving the photosensitive member 2 is fitted to the rotation shaft 2b of the photosensitive member 2. Incidentally, on the right side of the cleaning member 3o, a cleaning member drive gear 11 for rotating and driving the cleaning member 3o is fitted to the rotation shaft 3p of the cleaning member 3o. The photosensitive member drive gear 8 and the cleaning member drive gear 11 are connected to each other via an intermediate gear 12 rotatably supported on the main device body. When a driving force of a motor (not shown) is transmitted to the photosensitive member drive gear 8, the photosensitive member 2 starts rotating. When the driving force of the motor is further transmitted to the cleaning member driving gear 11 via the intermediate gear 12, the cleaning member 3o starts rotating. Since the charge roller 3a is pressed between the photosensitive member 2 and the cleaning member 3o, the charge roller 3a starts rotating with the rotational movements of the photosensitive member 2 and the cleaning member 3o by means of the frictional force between the charge roller 3a and the photosensitive member 2 and the cleaning member 3o.

The optical writing unit 4 writes the electrostatic latent images onto the photosensitive member 2 using laser beams, for example. The development unit 5 includes a development roller 5a, a toner supply roller 5b, and a toner thickness restriction member 5c. Specifically, the toner supply roller 5b supplies toner particles (not shown) as a developer onto the development roller 5a. The thickness of the toner particles on the development roller 5a is restricted by the toner thickness restriction member 5c. Then, the toner particles are transported toward the photosensitive member 2. The electrostatic latent images on the photosensitive member 2 are developed by the transported toner particles. Finally, toner images are formed on the photosensitive member 2.

The transfer unit 6 includes a transfer roller 6a. The toner images on the photosensitive member 2 are transferred onto a transfer medium 13 such as a transfer sheet or an intermediate transfer medium. When the toner images are transferred onto the transfer sheet serving as the transfer medium 13, the toner images on the transfer sheet are fixed by a fixing unit (not shown), and images are formed on the transfer sheet. When the toner images are transferred onto the intermediate transfer medium serving as the transfer medium 13, the toner images on the intermediate transfer medium are further transferred onto a transfer sheet. Then, the toner images on the transfer sheet are fixed by a fixing unit (not shown), and images are formed on the transfer sheet.

The cleaning unit 7 includes a cleaning member 7a such as a cleaning blade. The photosensitive member 2 is cleaned with the cleaning member 7a, and the toner particles remaining on the photosensitive member 2 after the transfer process are removed or collected by the cleaning operation.

Incidentally, the ends 7a₁ and 7a₂ of the cleaning blade 7a of the cleaning unit 7 are respectively positioned at positions located further out than the corresponding outer edges 3d₁ and 3e₁ of the first and second gap members 3d and 3e.

Next, relationships between the axial lengths and positions of the photosensitive member 2, charge roller 3a, development roller 5a, and cleaning blade 7a, used in the image forming apparatus 1 of the present embodiment will be described in detail.

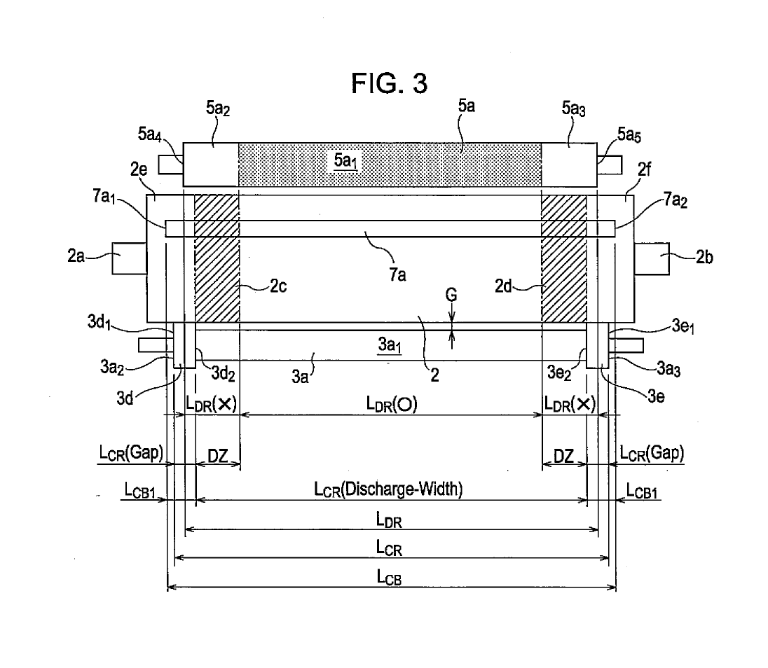

As shown in FIG. 3, the photosensitive member 2, the charge roller 3a, the development roller 5a, and the cleaning blade 7a are arranged such that they are axially aligned. In the present embodiment, the following axial lengths are set according to the relationships described below: the axial length of the photosensitive member 2; the axial length L_{CB (mm)} of the cleaning blade 7a; the axial length L_{CR (mm)} of the charge roller 3a; and the axial length L_{DR (mm)} of the development roller 5a.

A discharge width L_{CR} (discharge-width) (mm) of the charge roller 3a (here, the width corresponds to the axial length of the charging section 3a₁ between the first and second gap member 3d and 3e) is given as [L_{CR}−2L_{CR (Gap)}] (mm) (i.e., [the length L_{CR} (mm) of the charge roller 3a]−[the combined width 2L_{CR (Gap)} (mm) of the first and second gap members 3d and 3e]. That is, the outer edges 3d₁ and 3e₁ of the first and second gap member 3d and 3e correspond respectively to the ends 3a₂ and 3a₃ of the charge roller 3a.

Incidentally, the development roller 5a is formed by a toner transport section (toner developing area) 5a₁ positioned at the central portion in its axial direction, and non-toner transport sections 5a₂ and 5a₃ positioned between the ends of the toner transport section 5a₁ and the ends 5a₄ and 5a₅ of the development roller 5a. In the present embodiment, assuming that the axial length of the toner transport section 5a₁ (here, the length is referred to as width of the toner developing area) is L_{DR} (O) (mm), and the axial length of each of the non-toner transport sections 5a₂ and 5a₃ (here, the length is referred to as width of non-toner section) is L_{DR} (X) (mm), the total length (total width) L_{DR} (mm) of the development roller 5a is given as [L_{DR}(O)+2L_{DR}(X) (mm).

Incidentally, discharge dead zones are formed respectively at areas 2c and 2d on the photosensitive member 2 opposite the charge roller 3a between the inner edges 3d₂ and 3e₂ of the first and second gap members 3d and 3e and the toner transport section (toner developing section) 5a₁. Therefore, the ends 7a₁ and 7a₂ of the cleaning blade 7a are not present on the discharge dead zones 2c and 2d but on non-discharge areas 2e and 2f which are positioned outside of the discharge dead zones 2c and 2d and thus are not discharged (charged) by the charge roller 3a. The total axial length (width) 2DZ (mm) of the discharge dead zones 2c and 2d is given as [L_{CR}−L_{DR}(O)−2L_{CR}(Gap)](mm): i.e., [the length L_{CR} (mm) of the charge roller 3a]−[the width L_{DR}(O) (mm) of the toner developing section]−[the combined width 2L_{CR} (Gap) (mm) of the first and second gap members 3d and 3e]. That is, DZ (mm)=[L_{CR}−L_{DR}(O)−2L_{CR} (Gap)]/2 (mm).

In the image forming apparatus 1 of the present embodiment, the ends 7a₁ and 7a₂ of the cleaning blade 7a are not present on the discharge dead zones 2c and 2d but on the stabilized non-discharge areas 2e and 2f of the photosensitive member 2 having a smaller frictional coefficient than that of the discharge dead zones 2c and 2d. Therefore, it is possible to prevent the cleaning blade 7a from bending inward from the ends 7a₁ and 7a₂. Accordingly, the cleaning blade 7a can maintain its stable cleaning function for a long period, and it is thus possible to maintain a stable printing operation for a long period.

In this way, since it is possible to prevent the bending of the cleaning blade 7a, the width DZ (mm) of the discharge dead zones 2c and 2d of the photosensitive member 2 need not be further decreased by that extent but can be suitably set. Therefore, it is possible to suppress adhering of toner particles onto the gap members 3d and 3e which may occur when the width DZ (mm) of the discharge dead zones 2c and 2d is decreased. Incidentally, since the ends 7a₁ and 7a₂ of the cleaning blade 7a are positioned on the non-discharge areas 2e and 2f of the photosensitive member 2, it is possible to remove toner particles remaining on the photosensitive member 2 after the transfer process in a secured manner. Accordingly, it is possible to suppress adhering of toner particles on the gap members 3d and 3e.

With such a configuration, it is possible to maintain a stable printing operation for a long period while maintaining a constant charging gap G in a stable manner for a relatively long period.

Next, durability tests were performed to confirm the advantages of the invention.

Experimental Device

A color printer LP9000C (from Seiko Epson Corp.) was remodeled and used as an experimental device. Details of the experimental device are described in Table 1.

TABLE 1

| Element | Details | Note |
|---|---|---|
| Photosensitive | Photosensitive Drum | |
| Member | of LP9000C (from | |
| | Seiko Epson Corp.) | |
| Charge Roller | Non-contact Type | Resistor layer: made |
| | AC Charge Roller | from a mixture of |
| | Metal Shaft (φ: | conductive tin oxide |
| | 12 mm) + Upper | and polyurethane in |
| | Layer (Resistor | weight ratio of 1:1 |
| | Layer 30 μm) | Resistance: 2.0 × 10⁶ Ω |
| | Polyester-based | |
| | tape-like gap | |
| | member at both ends | |
| | Gap less than 20 μm | |
| Cleaning Blade | Cleaning Blade of | |
| | LP9000C (from | |
| | Seiko Epson Corp.) | |
| Optical Writing | Exposure Unit of | |
| Unit | LP9000C (from | |
| | Seiko Epson Corp.) | |
| Development | Development Unit | Including Toner |
| Unit | of LP9000C (from | |
| | Seiko Epson Corp.) | |
| Transfer Belt | Transfer Belt of | |
| | LP9000C (from | |
| | Seiko Epson Corp.) | |
| Fixing Unit | Fixing Unit of | |
| | LP9000C (from | |
| | Seiko Epson Corp.) | |
| High-Voltage | Trek (AC Output) | |
| Power Supply | (from US TREK, | |
| | INC) | |

As shown in Table 1, the image forming apparatus as the experimental device includes a photosensitive drum of a color printer LP9000C (from Seiko Epson Corp.) as a photosensitive member, a cleaning blade (made of urethane rubber) of the LP9000C as a cleaning blade, an optical writing unit of the LP9000C as an optical writing unit, a development unit (including the authentic toner) of the LP9000C as a development unit, an intermediate transfer belt of the LP9000C as an intermediate transfer belt, and a fixing unit of the LP9000C as a fixing unit. The charge roller used was a non-contact type charge roller, in which a metal shaft (φ: 12 mm) was used and its upper layer was covered with a resistor layer having a thickness of 30 μm. The resistor layer was made from a mixture of conductive tin oxide and polyurethane in a weight ratio of 1:1, and the resistor layer had a resistance of 2.0×10⁶Ω. Incidentally, a polyester-based tape-like gap member for forming a charge gap was formed on both sides of the resistor layer which was then wound around the upper layer of the charge roller. The charge gap was set to 20 μm. An existing power supply, Trek (AC output) (from US TREK, INC.), was used as a high-voltage AC power supply, and a hand-made DC power supply was used. By using the above-described components, the image forming apparatus shown in FIG. 1 was produced.

Although not described in Table 1, an existing sponge, EPT-51 (from Bridgestone Kaseihin Tokyo Co., Ltd.), was used as the sponge of the roller-shaped cleaning member 3o for cleaning the charge roller. The thickness of the sponge was 0.3 mm, and the rotation speed of the cleaning member was set to 80% of the rotation speed of the charge roller 3a.

Experimental Conditions and Results

Printing tests were conducted on Test Item Nos. 1 to 6. Basically, the printing tests were conducted on Test Item Nos. 1 to 6 under the following common experimental conditions. As a charging voltage to be applied to the charge roller 3a, an overlapping voltage of DC voltage V_{dc} and AC voltage Vₚₚ was used. The DC voltage V_{dc} was −600 V and the AC voltage Vₚₚ was 1800 V. Sinusoidal waves with a frequency of 1.3 kHz were used as the AC voltage Vₚₚ. The processing speed was 210 mm/sec, and the ratio of the rotation speed of the charge roller 3a to that of the photosensitive member 2 was set to 1. As a developing voltage, an overlapping voltage of DC voltage V_{DC} and AC voltage Vₚₚ was used. The DC voltage VDC was −200 V and the AC voltage Vₚₚ was 1400 V. Rectangular waves (duty ratio: 50%) with a frequency of 1.0 kHz were used as the AC voltage Vₚₚ, and a transfer voltage of +200 V was used.

Individual experimental conditions for Test Item Nos. 1 to 6 are described in Table 2.

TABLE 2

| | Charge Roller | | | | | | | | |
|---|---|---|---|---|---|---|---|---|---|
| | | L_{CR} | | Development | | | | | |
| | | (Dis- | | Roller | | | | | |
| | | charge- | L_{CR} | | L_{DR} | L_{DR} | | Blade | |
| No. | L_{CB} | Width) | (Gap) | L_{DR} | (◯) | (X) | DZ | L_{CB} | Result |
| 1 | 320 | 300 | 10 | 320 | 290 | 15 | 5 | 315 | ◯ |
| 2 | 320 | 300 | 10 | 320 | 290 | 15 | 5 | 325 | ◯ |
| 3 | 320 | 300 | 10 | 320 | 290 | 15 | 5 | 295 | X (655 |
| | | | | | | | | | Pages) |
| 4 | 320 | 310 | 5 | 315 | 290 | 12.5 | 10 | 295 | X (845 |
| | | | | | | | | | Pages) |
| 5 | 320 | 310 | 5 | 315 | 290 | 12.5 | 10 | 320 | ◯ |
| 6 | 320 | 310 | 5 | 315 | 290 | 12.5 | 10 | 330 | ◯ |

L_{CR}: Total width of charge roller (discharge section + gap members at both sides)
L_{CR} (Discharge-Width): Width of discharge section in charge roller
L_{CR} (Gap): Width (single-side) of gap section at both sides of charge roller
L_{DR}: Total width of development roller (toner developing section + non-toner section)
L_{DR} (◯): Width of toner developing section in development roller
L_{DR} (X): Width (single-side) of non-toner section in development roller
DZ: Discharge dead zone (single-side width)
Blade: Width of blade
The widths were measured in units of mm.

As described in Table 2, the experimental conditions for Test Item No. 1 are as follows: the length LCR (mm) of the charge roller 3a is 320 mm, the length LCR (discharge-width) (mm) of the charging section in the charge roller 3a is 300 mm, the width L_{CR} (Gap) (mm) of each of the gap members 3d and 3e is 10 mm, the length L_{DR} (mm) of the development roller 5a is 320 mm, the width L_{DR} (O) (mm) of the toner developing section in the development roller 5a is 290 mm, the width L_{DR} (X) (mm) of the non-toner section in the development roller 5a is 15 mm, the length L_{CB} (mm) of the cleaning blade 7a is 315 mm, and the width DZ (mm) of each of the discharge dead zones 2c and 2d is 5 mm.

The experimental conditions for Test Item No. 2 are the same as the experimental conditions for Test Item No. 1, except that the length LCB (mm) of the cleaning blade 7a is 325 mm for Test Item No. 2. In addition, the experimental conditions for Test Item No. 3 are the same as the experimental conditions for Test Item No. 1, except that the length LCB (mm) of the cleaning blade 7a is 295 mm for Test Item No. 3.

The experimental conditions for Test Item No. 4 are as follows: the length L_{CR} (mm) of the charge roller 3a is 320 mm, the length LCR (discharge-width) (mm) of the charging section in the charge roller 3a is 310 mm, the width LCR (Gap) (mm) of each of the gap members 3d and 3e is 5 mm, the length L_{DR} (mm) of the development roller 5a is 315 mm, the width L_{DR} (O) (mm) of the toner developing section in the development roller 5a is 290 mm, the width L_{DR} (X) (mm) of the non-toner section in the development roller 5a is 12.5 mm, the length L_{CB} (mm) of the cleaning blade 7a is 295 mm, and the width DZ (mm) of each of the discharge dead zones 2c and 2d is 10 mm.

The experimental conditions for Test Item No. 5 are the same as the experimental conditions for Test Item No. 4, except that the length L_{CB} (mm) of the cleaning blade 7a is 320 mm for Test Item No. 5. In addition, the experimental conditions for Test Item No. 6 are the same as the experimental conditions for Test Item No. 4, except that the length LCB (mm) of the cleaning blade 7a is 330 mm for Test Item No. 6.

Printing Test

The printing tests were made under certain environmental conditions such as a high temperature of 35° C. and a high humidity of 65% (in relative humidity). Under such environmental conditions, a number of solid printing operations based on monochrome and halftone images were continuously performed on the entire face of an A4-size standard sheet for 10000 pages.

Results

The test results are described in Table 2. In Table 2, if the bending of the cleaning blade 7a was not observed even after the solid printing operations were continuously performed for 10000 pages, the result was represented by the symbol O. Meanwhile, if the bending of the cleaning blade 7a was observed in the course of the printing operations, the result was represented by the symbol X.

As can be seen from Table 2, even after the solid printing operations were continuously performed for 10000 pages, the bending of the cleaning blade 7a under the experimental conditions for Test Item Nos. 1 to 6 relating to the invention was not observed. Under the experimental conditions for Test Item No. 3, the bending of the cleaning blade 7a was observed when the solid printing operations were continuously performed for 655 pages. Under the experimental conditions for Test Item No. 4, the bending of the cleaning blade 7a was observed when the solid printing operations were continuously performed for 845 pages. Accordingly, the advantages of the invention were confirmed.

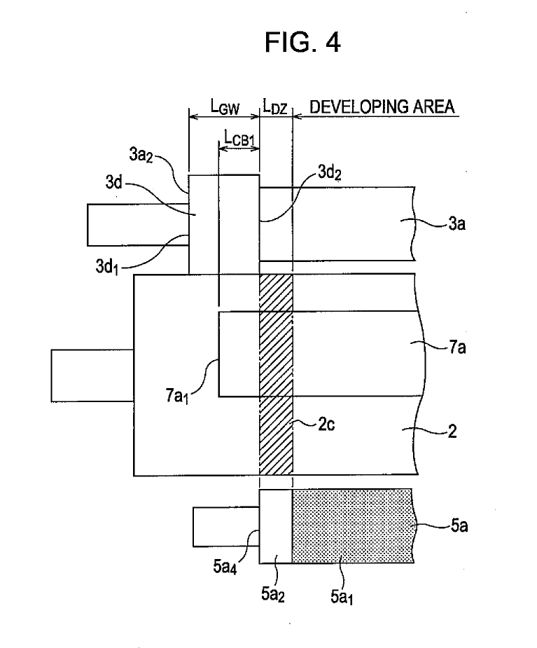

FIG. 4 is a diagram showing configurations of a photosensitive member, a charge roller, and a cleaning member of the charge roller, used in an image forming apparatus in accordance with a second exemplary embodiment of the invention, in which only left-side configurations of the components are shown. In the present embodiment, the left-side configurations of the photosensitive member, charge roller, and cleaning member of the charge roller are symmetrical to the right-side configurations in a manner similar to the case of the embodiment shown in FIG. 3. Therefore, the reference numerals for the components (not shown in FIG. 4) on the right side of the drawing are also referred in the following descriptions relating to FIG. 4. In this case, the components (not shown in FIG. 4) on the right side of the drawing are referred by those reference numerals for the components shown in FIG. 3 on the right side of the drawing.

As shown in FIG. 4, in the image forming apparatus 1 of the present embodiment, the ends 7a₁ and 7a₂ of the cleaning blade 7a are respectively positioned between the outer edges 3d₁ and 3e₁ and the inner edges 3d₂ and 3e₂ of the first and second gap members 3d and 3e. That is, the ends 7a₁ and 7a₂ of the cleaning blade 7a are positioned within the width L_{GW} (mm) of each of the first and second gap members 3d and 3e. The width L_{GW} (mm) of each of the first and second gap members 3d and 3e is set equal to L_{CR} (Gap) (mm) in the first embodiment. The positions of the inner edges 3d₂ and 3e₂ of the gap members 3d and 3e correspond to the positions of the ends 5a₄ and 5a₅ of the development roller 5a in the axial direction.

The axial length (width) L_{DZ} (mm) of each of the discharge dead zones 2c and 2d, the axial length L_{CB1} (mm) between the inner edges 3d₂ and 3e₂ of the gap members 3d and 3e and the ends 7a₁ and 7a₂ of the cleaning blade 7a are set to satisfy a relationship of (L_{CB1}/L_{DZ})>1. That is, the axial length L_{CB1} (mm) is set greater than the axial length L_{DZ} (mm) of the discharge dead zones 2c and 2d. The axial length L_{DZ} (mm) of the discharge dead zones 2c and 2d is set equal to the DZ (Gap) (mm) in the first embodiment.

With such a positional relationship between the discharge dead zones 2c and 2d and the cleaning blade 7a, it is possible to prevent the bending of the cleaning blade 7a even after operating the image forming apparatus 1 for a long period. Therefore, in the image forming apparatus 1 of the present embodiment, it is possible to prolong the lifetime of the cleaning blade 7a and improve stability of an overall process.

This is because the following matters are considered in a process in which a non-contact type charging operation using AC voltage and a non-contact type development operation using AC voltage are performed using nonmagnetic mono-component toner particles. That is, in such a process of supplying a large amount of AC current to the photosensitive member 2, it has been known that characteristics of the surface of the photosensitive member 2 are deteriorated by the influence of the charging and development operations (see, Japan Hardcopy 2003, pages 61 to 64, for example). As a result of various experiments, the present inventors have found that the deterioration in the characteristics of the photosensitive member 2 indicated a difference from area to area on the surface of the photosensitive member 2: i.e., between the areas having adhering materials such as toner particles formed thereon (this area corresponds to the toner developing area) and the remaining areas (so-called discharge dead zone). In particular, such a difference became prominent when the photosensitive member 2 was used for a long period. That is, the characteristic deterioration of the photosensitive member 2 became prominent in the discharge dead zone.

On the other hand, in a practical process, it is necessary to set the charging width and the development width to satisfy a relationship of [charging width]>[development width]. For this reason, the discharge dead zones are present at both ends of the photosensitive member 2. However, in the case of using the cleaning blade 7a, if the discharge dead zones are present on the sides 7a₁ and 7a₂ of the cleaning blade 7a, so-called bending of the cleaning blade 7a is likely to occur. In view of the foregoing matters, by configuring the discharge dead zones 2c and 2d and the cleaning blade 7a to satisfy the above-mentioned relationship, it is possible to prevent the bending of the cleaning blade 7a for a long period.

Other configurations and effects of the image forming apparatus 1 of the present embodiment are the same as those of the embodiment shown in FIG. 3.

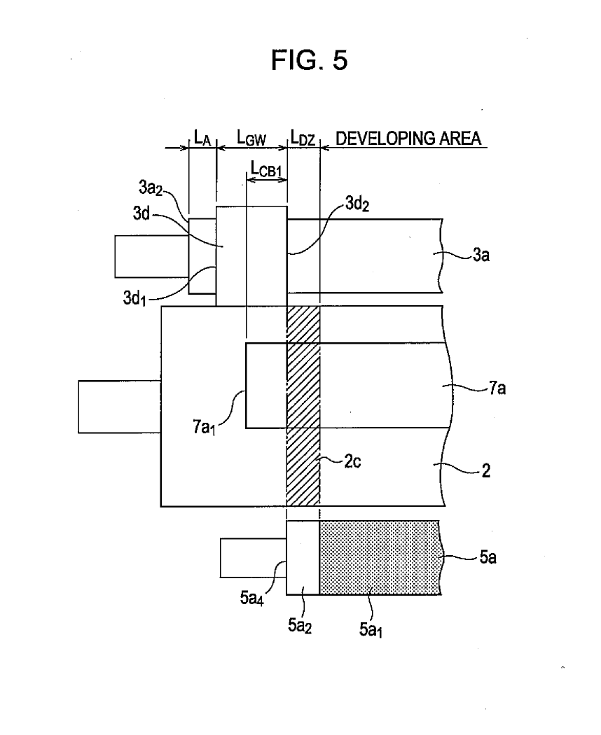

FIG. 5 is a diagram showing configurations of a photosensitive member, a charge roller, and a cleaning member of the charge roller, used in an image forming apparatus in accordance with a third exemplary embodiment of the invention, in which only left-side configurations of the components are shown. In the present embodiment, the left-side configurations of the photosensitive member, charge roller, and cleaning member of the charge roller are symmetrical to the right-side configuration thereof in a similar manner to the case of the embodiment shown in FIG. 3.

In the embodiment shown in FIG. 4, the outer edges 3d₁ and 3e₁ of the first and second gap member 3d and 3e are respectively corresponding in position to the corresponding edges 3a₂ and 3a₃ of the charge roller 3a. To the contrary, as shown in FIG. 4, in the image forming apparatus 1 of the present embodiment, the outer edges 3d₁ and 3e₁ of the first and second gap members 3d and 3e are respectively displaced from the corresponding edges 3a₂ and 3a₃ of the charge roller 3a toward inner side (toward the central portion in the axial direction of the charge roller 3a) by the amount of L_{A} (mm).

Other configurations of the image forming apparatus 1 of the present embodiment are the same as those of the embodiment shown in FIG. 4.

Next, durability tests were performed to confirm the advantage of the image forming apparatus 1 shown in FIGS. 4 and 5. The experiments were performed under experimental conditions Nos. 7 to 32. As types of the cleaning blade 7a, three types of blades A, B, and C were used. Details of the blades A, B, and C are described in Table 3.

TABLE 3

| | | Blade Type | | | |
|---|---|---|---|---|---|
| | | A | B | C | |
| | | Sub- | Sub- | Sub- | |
| Item | | stance | stance | stance | |
| Characteristic | | No. | No. | No. | Measuring |
| Item | Unit | 238640 | 238678 | 238778 | Method |
| Hardness | JIS-A | 64 | 67 | 77 | JIS K6301 |
| Repulsive | % | 42 | 50 | 51 | JIS K6301 (at |
| Elasticity | | | | | 25° C.) |
| Young's | MPa | 5.1 | 5.6 | 8.5 | JIS K6254 (25% |
| Modulus | | | | | elongation) |
| 100% Modulus | MPa | 2.2 | 2.9 | 4 | JIS K6254 |
| 300% Modulus | MPa | — | 10.8 | 14.7 | JIS K6251 |
| Tensile | MPa | 13.7 | 26.5 | 33.3 | JIS K6251 |
| strength | | | | | |
| Elongation at | % | 300 | 350 | 330 | JIS K6251 |
| break | | | | | |
| Tear strength | KN/m | 39.2 | 39.2 | 68.6 | JIS K6252 |
| Permanent | % | 0.8 | 1.1 | 2.2 | JIS K6262 (Paper |
| elongation | | | | | Strip Size: No. 1, |
| | | | | | Duration: 20 |
| | | | | | minutes) |

As described in Table 3, the blade A corresponds to a substance No. 238640, the blade B corresponds to a substance No. 238678, and the blade C corresponds to a substance No. 238778. The hardness of the blade A was 64 in the unit of JIS-A, the hardness of the blade B was 67 in the unit of JIS-A, and the hardness of the blade C was 77 in the unit of JIS-A. The hardness tests were conducted in accordance with JIS K6301. The repulsive elasticity of the blade A was 42%, the repulsive elasticity of the blade B was 50%, and the repulsive elasticity of the blade C was 51%. The repulsive elasticity tests were conducted in accordance with JIS K6301 (at 25° C.). The Young's modulus of the blade A was 5.1 MPa, the Young's modulus of the blade B was 5.6 MPa, and the Young's modulus of the blade C was 8.5 MPa. The Young's modulus tests were conducted in accordance with Jis K6254 (25% elongation). The 100% modulus of the blade A was 2.2 MPa, the 100% modulus of the blade B was 2.9 MPa, and the 100% modulus of the blade C was 4.0 MPa. The 100% modulus tests were conducted in accordance with JIS K6254. The 300% modulus of the blade A was out of measurable range, the 300% modulus of the blade B was 10.8 MPa, and the 300% modulus of the blade C was 14.7 MPa. The 300% modulus tests were conducted in accordance with JIS K6251. The tensile strength of the blade A was 13.7 MPa, the tensile strength of the blade B was 26.5 MPa, and the tensile strength of the blade C was 33.3 MPa. The tensile strength tests were conducted in accordance with JIS K6251. The elongation at break of the blade A was 300%, the elongation at break of the blade B was 350%, and the elongation at break of the blade C was 330%. The elongation-at-break tests were conducted in accordance with JIS K6251. The tear strength of the blade A was 39.2 KN/m, the tear strength of the blade B was 39.2 KN/m, and the tear strength of the blade C was 68.6 KN/m. The tear strength tests were conducted in accordance with JIS K6252. The permanent elongation of the blade A was 0.8%, the permanent elongation of the blade B was 1.1, and the permanent elongation of the blade C was 2.2%. The permanent elongation tests were conducted in accordance with JIS K6262 (paper strip size: No. 1, Duration: 20 minutes).

Other experimental conditions other than the following experimental conditions are the same as those of the above-described experiments. Experimental conditions Nos. 7 to 32 are described in Table 4.

TABLE 4

| | Charge | | | | | | | | Bending/ | |
|---|---|---|---|---|---|---|---|---|---|---|
| | Roller | L_{DZ} | L_{CB1} | L_{GW} | Blade | | Pressure | Angle | Pages | |
| No. | Shape | (mm) | (mm) | (mm) | Type | L_{CB1}/L_{DZ} | (g/cm) | (°) | (p) | Judgement |
| 7 | CR1 | 2 | 6 | 8 | A | 3 | 15 | 17 | Clear | ◯ |
| 8 | CR1 | 8 | 7.5 | 5 | A | 0.94 | 15 | 17 | 78 | X |
| 9 | CR1 | 5 | 6 | 5 | B | 1.2 | 18 | 18 | Clear | ◯ |
| 10 | CR1 | 5 | 10 | 15 | B | 2 | 18 | 15 | Clear | ◯ |
| 11 | CR1 | 8 | 7 | 9 | A | 0.88 | 18 | 18 | 129 | X |
| 12 | CR1 | 7 | 8 | 5 | C | 1.14 | 22 | 18 | Clear | ◯ |
| 13 | CR1 | 7 | 18 | 15 | C | 2.57 | 22 | 16 | Clear | ◯ |
| 14 | CR1 | 7 | 6 | 7 | C | 0.86 | 20 | 20 | 105 | X |
| 15 | CR1 | 10 | 5 | 8 | A | 0.5 | 25 | 14 | 211 | X |
| 16 | CR1 | 10 | 29 | 4 | A | 2.9 | 25 | 15 | Clear | ◯ |
| 17 | CR1 | 10 | 9.8 | 5 | A | 0.98 | 24 | 17 | 189 | X |
| 18 | CR1 | 20 | 8 | 9 | B | 0.4 | 28 | 16 | 174 | X |
| 19 | CR1 | 20 | 22 | 15 | B | 2.2 | 30 | 16 | Clear | ◯ |
| 20 | CR2 | 2 | 6 | 8 | A | 3 | 15 | 17 | Clear | ◯ |
| 21 | CR2 | 8 | 7.5 | 5 | A | 0.94 | 15 | 17 | 78 | X |
| 22 | CR2 | 5 | 6 | 5 | B | 1.2 | 18 | 18 | 177 | X |
| 23 | CR2 | 5 | 10 | 15 | B | 2 | 18 | 15 | Clear | ◯ |
| 24 | CR2 | 8 | 7 | 9 | A | 0.88 | 18 | 18 | 128 | X |
| 25 | CR2 | 7 | 8 | 5 | C | 1.14 | 22 | 18 | 111 | X |
| 26 | CR2 | 7 | 18 | 15 | C | 2.57 | 22 | 16 | 122 | X |
| 27 | CR2 | 7 | 6 | 7 | C | 0.86 | 20 | 20 | 105 | X |
| 28 | CR2 | 10 | 5 | 8 | A | 0.5 | 25 | 14 | 211 | X |
| 29 | CR2 | 10 | 29 | 4 | A | 2.9 | 25 | 15 | 227 | X |
| 30 | CR2 | 10 | 9.8 | 5 | A | 0.98 | 24 | 17 | 189 | X |
| 31 | CR2 | 20 | 8 | 9 | B | 0.4 | 28 | 16 | 174 | X |
| 32 | CR2 | 20 | 22 | 15 | B | 2.2 | 30 | 16 | 177 | X |

In Table 3, the shape CR1 of the charge roller 3a corresponds to the shape of the charge roller 3a shown in FIG. 4, and the shape CR2 of the charge roller 3a corresponds to the shape of the charge roller 3a shown in FIG. 5. In this experiment, the charge roller 3a having the shape CR1 is used in Test Item Nos. 7 to 19, and the charge roller 3a having the shape CR2 is used in Test Item Nos. 20 to 32. In Test Item Nos. 20 to 32, the charge roller 3a having the shape CR2 was configured such that the length LA (mm) between the outer edges 3d₁ and 3e₁ of the first and second gap members 3d and 3e and the corresponding edges 3a₂ and 3a₃ of the charge roller 3a is set to 2 mm.

In Table 3, the angle (O) is an angle formed between the axial line of the cleaning blade 7a and a tangential line at a contact point at which the cleaning blade 7a is in contact with the photosensitive member 2, as shown in FIG. 1.

As described in Table 3, the experimental conditions for Test Item No. 7 are as follows: the axial length L_{DZ} (mm) of the discharge dead zones 2c and 2d is set to 2 mm, the axial length L_{CB1} (mm) between the inner edges 3d₂ and 3e₂ of the gap members 3d and 3e and the ends 7a₁ and 7a₂ of the cleaning blade 7a is set to 6 mm, the width L_{GW} (mm) of the gap members 3d and 3e is set to 8 mm, the type of the cleaning blade 7a is A, L_{CB1}/L_{DZ} is 3.0, the pressure (g/cm) applied from the cleaning blade 7a to the photosensitive member 2 is 15 g/cm, and the angle (°) is 17°.

The experimental conditions for Test Item No. 8 are as follows: L_{DZ} (mm) is 8 mm, L_{CB1} (mm) is 7.5 mm, L_{GW} (mm) is 5 mm, the type of the cleaning blade 7a is A, L_{CB1}/L_{DZ} is 0.94, the pressure (g/cm) is 15 g/cm, and the angle (°) is 17°.

The experimental conditions for Test Item No. 9 are as follows: L_{DZ} (mm) is 5 mm, L_{CB1} (mm) is 6 mm, L_{GW} (mm) is 5 mm, the type of the cleaning blade 7a is B, L_{CB1}/L_{DZ} is 1.2, the pressure (g/cm) is 18 g/cm, and the angle (°) is 18°.

The experimental conditions for Test Item No. 10 are as follows: L_{DZ} (mm) is 5 mm, L_{CB1} (mm) is 10 mm, L_{GW} (mm) is 15 mm, the type of the cleaning blade 7a is B, L_{CB1}/L_{DZ} is 2.0, the pressure (g/cm) is 18 g/cm, and the angle (°) is 15°.

The experimental conditions for Test Item No. 11 are as follows: L_{DZ} (mm) is 8 mm, L_{CB1} (mm) is 7 mm, L_{GW} (mm) is 9 mm, the type of the cleaning blade 7a is A, L_{CB1}/L_{DZ} is 0.88, the pressure (g/cm) is 18 g/cm, and the angle (°) is 18°.

The experimental conditions for Test Item No. 12 are as follows: L_{DZ} (mm) is 7 mm, L_{CB1} (mm) is 8 mm, L_{GW} (mm) is 5 mm, the type of the cleaning blade 7a is C, L_{CB1}/L_{DZ} is 1.14, the pressure (g/cm) is 22 g/cm, and the angle (°) is 18°.

The experimental conditions for Test Item No. 13 are as follows: L_{DZ} (mm) is 7 mm, L_{CB1} (mm) is 18 mm, L_{GW} (mm) is 15 mm, the type of the cleaning blade 7a is C, L_{CB1}/L_{DZ} is 2.57, the pressure (g/cm) is 22 g/cm, and the angle (°) is 16°.

The experimental conditions for Test Item No. 14 are as follows: L_{DZ} (mm) is 7 mm, L_{CB1} (mm) is 6 mm, L_{GW} (mm) is 7 mm, the type of the cleaning blade 7a is C, L_{CB1}/L_{DZ} is 0.86, the pressure (g/cm) is 20 g/cm, and the angle (°) is 20°.

The experimental conditions for Test Item No. 15 are as follows: L_{DZ} (mm) is 10 mm, L_{CB1} (mm) is 5 mm, L_{GW} (mm) is 3 mm, the type of the cleaning blade 7a is A, L_{CB1}/L_{DZ} is 0.5, the pressure (g/cm) is 25 g/cm, and the angle (°) is 14°.

The experimental conditions for Test Item No. 16 are as follows: L_{DZ} (mm) is 10 mm, L_{CB1} (mm) is 29 mm, L_{GW} (mm) is 4 mm, the type of the cleaning blade 7a is A, L_{CB1}/L_{DZ} is 2.9, the pressure (g/cm) is 25 g/cm, and the angle (°) is 15°.

The experimental conditions for Test Item No. 17 are as follows: L_{DZ} (mm) is 10 mm, L_{CB1} (mm) is 9.8 mm, L_{GW} (mm) is 5 mm, the type of the cleaning blade 7a is A, L_{CB1}/L_{DZ} is 0.98, the pressure (g/cm) is 24 g/cm, and the angle (°) is 17°.

The experimental conditions for Test Item No. 18 are as follows: L_{DZ} (mm) is 20 mm, L_{CB1} (mm) is 8 mm, L_{GW} (mm) is 9 mm, the type of the cleaning blade 7a is B, L_{CB1}/L_{DZ} is 0.4, the pressure (g/cm) is 28 g/cm, and the angle (°) is 16°.

The experimental conditions for Test Item No. 19 are as follows: L_{DZ} (mm) is 20 mm, L_{CB1} (mm) is 22 mm, L_{GW} (mm) is 15 mm, the type of the cleaning blade 7a is B, L_{CB1}/L_{DZ} is 2.2, the pressure (g/cm) is 30 g/cm, and the angle (°) is 16°.

The experimental conditions for Test Item No. 20 are as follows: L_{DZ} (mm) is 2 mm, L_{CB1} (mm) is 6 mm, L_{GW} (mm) is 8 mm, the type of the cleaning blade 7a is A, L_{CB1}/L_{DZ} is 3.0, the pressure (g/cm) is 15 g/cm, and the angle (°) is 17°.

The experimental conditions for Test Item No. 21 are as follows: L_{DZ} (mm) is 8 mm, L_{CB1} (mm) is 7.5 mm, L_{GW} (mm) is 5 mm, the type of the cleaning blade 7a is A, L_{CB1}/L_{DZ} is 0.94, the pressure (g/cm) is 15 g/cm, and the angle (°) is 17°.

The experimental conditions for Test Item No. 22 are as follows: L_{DZ} (mm) is 5 mm, L_{CB1} (mm) is 6 mm, L_{CW} (mm) is 5 mm, the type of the cleaning blade 7a is B, L_{CB1}/L_{DZ} is 1.2, the pressure (g/cm) is 18 g/cm, and the angle (°) is 18°.

The experimental conditions for Test Item No. 23 are as follows: L_{DZ} (mm) is 5 mm, L_{CB1} (mm) is 10 mm, L_{GW} (mm) is 15 mm, the type of the cleaning blade 7a is B, L_{CB1}/L_{DZ} is 2.0, the pressure (g/cm) is 18 g/cm, and the angle (°) is 15°.

The experimental conditions for Test Item No. 24 are as follows: L_{DZ} (mm) is 8 mm, L_{CB1} (mm) is 7 mm, L_{GW} (mm) is 9 mm, the type of the cleaning blade 7a is A, L_{CB1}/L_{DZ} is 0.88, the pressure (g/cm) is 18 g/cm, and the angle (°) is 18°.

The experimental conditions for Test Item No. 25 are as follows: L_{DZ} (mm) is 7 mm, L_{CB1} (mm) is 8 mm, L_{GW} (mm) is 5 mm, the type of the cleaning blade 7a is C, L_{CB1}/L_{DZ} is 1.14, the pressure (g/cm) is 22 g/cm, and the angle (°) is 18°.

The experimental conditions for Test Item No. 26 are as follows: L_{DZ} (mm) is 7 mm, L_{CB1} (mm) is 1.8 mm, L_{CW} (mm) is 15 mm, the type of the cleaning blade 7a is C, L_{CB1}/L_{DZ} is 2.57, the pressure (g/cm) is 22 g/cm, and the angle (°) is 16°.

The experimental conditions for Test Item No. 27 are as follows: L_{DZ} (mm) is 7 mm, L_{CB1} (mm) is 6 mm, L_{GW} (mm) is 7 mm, the type of the cleaning blade 7a is C, L_{CB1}/L_{DZ} is 0.86, the pressure (g/cm) is 20 g/cm, and the angle (°) is 20°.

The experimental conditions for Test Item No. 28 are as follows: L_{DZ} (mm) is 10 mm, L_{CB1} (mm) is 5 mm, L_{GW} (mm) is 8 mm, the type of the cleaning blade 7a is A, L_{CB1}/L_{DZ} is 0.5, the pressure (g/cm) is 25 g/cm, and the angle (°) is 14°.

The experimental conditions for Test Item No. 29 are as follows: L_{DZ} (mm) is 10 mm, L_{CB1} (mm) is 29 mm, L_{CW} (mm) is 4 mm, the type of the cleaning blade 7a is A, L_{CB1}/L_{DZ} is 2.9, the pressure (g/cm) is 25 g/cm, and the angle (°) is 15°.

The experimental conditions for Test Item No. 30 are as follows: L_{DZ} (mm) is 10 mm, L_{CB1} (mm) is 9.8 mm, L_{GW} (mm) is 5 mm, the type of the cleaning blade 7a is A, L_{CB1}/L_{DZ} is 0.98, the pressure (g/cm) is 24 g/cm, and the angle (°) is 17°.

The experimental conditions for Test Item No. 31 are as follows: L_{DZ} (mm) is 20 mm, L_{CB1} (mm) is 8 mm, L_{GW} (mm) is 9 mm, the type of the cleaning blade 7a is B, L_{CB1}/L_{DZ} is 0.4, the pressure (g/cm) is 28 g/cm, and the angle (°) is 16°.

The experimental conditions for Test Item No. 32 are as follows: L_{DZ} (mm) is 20 mm, L_{CB1} (mm) is 22 mm, L_{GW} (mm) is 15 mm, the type of the cleaning blade 7a is B, L_{CB1}/L_{DZ} is 2.2, the pressure (g/cm) is 30 g/cm, and the angle (°) is 16°.

Printing Test

The printing tests were conducted by continuously performing a number of printing operations at 5% coverage onto A4-size standard sheet for 20000 pages.

Test Results

The test results are described in Table 4. In Table 4, if the bending of the cleaning blade 7a was not observed even after the printing operations were continuously performed for 20000 pages, the result was represented by the letter “Clear”. Meanwhile, if the bending of the cleaning blade 7a was observed in the course of the printing operations, the number of printed pages was filled into the table. If the printing operations were perfect, it is judged to be “Clear” and the symbol O is filled into the table. Meanwhile, if the printing operations were not perfect, it not is judged to be “Clear” and the symbol X is filled into the table.

As can be seen from Table 4, in the case of the charge roller 3a having the shape CR1, when the L_{CB1}/L_{DZ} is greater than 1.14, it was possible to perform the continuous printing operations onto 20000 pages in a perfect manner in a state that the bending of the cleaning blade 7a was not observed. Thus, a good result was obtained. Meanwhile, when the L_{CB1}/L_{DZ} is smaller than 0.98, the bending of the cleaning blade 7a was observed even before the continuous printing operations were performed up to several hundreds of pages. Thus, a poor result was obtained. Accordingly, it is confirmed that when the L_{CB1}/L_{DZ} was set greater than 1, the bending of the cleaning blade 7a can be suppressed even after performing the continuous printing operations onto 20000 pages, and that the advantages of the invention can be achieved.

Meanwhile, in the case of the charge roller 3a having the shape CR2, even when the L_{CB1}/L_{DZ} is greater than 1, the bending of the cleaning blade 7a was observed even before the continuous printing operations were performed up to several hundreds of pages. Such a bad result was observed in Test Item Nos. 22, 25, 26, 29, and 32. The cleaning blade 7a related to those test items had the following relationship: L_{CB1}>L_{GW}. That is, it is confirmed that the cleaning blade 7a had a configuration in which the ends 7a₁ and 7a₂ of the cleaning blade 7a were not positioned on the corresponding areas of the first and second gap members 3d and 3e but positioned outside of the outer edges 3d₁ and 3e₁ of the first and second gap members 3d and 3e.

incidentally, even when the L_{CB1}/L_{DZ} is greater than 1, it was possible to perform the continuous printing operations onto 20000 pages in a perfect manner in a state that the bending of the cleaning blade 7a was not observed. Thus, a good result was obtained. Such a good result was observed in Test Item Nos. 20 and 23. The cleaning blade 7a related to those test items had the following relationship: L_{CB1}<L_{GW}. That is, the cleaning blade 7a had a configuration in which the ends 7a₁ and 7a₂ of the cleaning blade 7a were positioned on the corresponding areas of the first and second gap members 3d and 3e.

Meanwhile, in the case of Test Item Nos. 21, 24, 27, 28, 30, and 31, using the L_{CB1}/L_{DZ} smaller than 1, the bending of the cleaning blade 7a was observed even before the continuous printing operations were performed up to several hundreds of pages. Thus, a poor result was obtained. Accordingly, it is confirmed that when the outer edges 3d₁ and 3e₁ of the first and second gap members 3d and 3e are positioned at a more inner side (toward the central portion in the axial direction of the charge roller 3a) than the corresponding edges 3a₂ and 3a₃ of the charge roller 3a, by setting the L_{CB1}/L_{DZ} greater than 1 and setting the L_{CB1} smaller than the L_{GW}, the bending of the cleaning blade 7a can be suppressed even after performing the continuous printing operations onto 20000 pages, and that the advantages of the invention can be achieved.

What is claimed is:

1. An image forming apparatus, comprising:
an image carrying member onto which electrostatic latent images and developer images are formed;
a charge unit that charges the image carrying member in a non-contact manner using a charge roller;
a development unit that develops the electrostatic latent images on the image carrying member with a developer transported by a development roller;
a transfer unit that transfers the developer images on the image carrying member onto a transfer medium;
a cleaning unit that removes a transfer-residual developer remaining on the image carrying medium after the developer images are transferred onto the transfer medium, using a cleaning blade making contact with the image carrying member;
a first gap member having electrical insulation properties that is fixed onto one end of the charge roller and pressed onto an outer peripheral surface of the image carrying member, thereby forming a charging gap; and
a second gap member having electrical insulation properties that is fixed onto the other end of the charge roller and pressed onto the outer peripheral surface of the image carrying member, thereby forming a charging gap,
wherein the first and second gap members are fixed onto the charge roller so that the positions of the outer edges of the first and second gap members correspond to the positions of corresponding edges of the charge roller,
wherein discharge dead zones are disposed between the inner edges of the first and second gap members and both ends of a developer-developing area on the development roller, and
wherein the cleaning blade is disposed such that the ends of the cleaning blade are positioned outside of the inner edges of the first and second gap members.

2. The image forming apparatus according to claim 1, wherein the ends of the cleaning blade are positioned outside of the outer edges of the first and second gap members.

3. The image forming apparatus according to claim 1, wherein axial lengths between the ends of the cleaning blade and corresponding inner edges of the first and second gap members are set so as to be larger than axial lengths of the discharge dead zones.

4. An image forming apparatus, comprising:
an image carrying member onto which electrostatic latent images and developer images are formed;
a charge unit that charges the image carrying member in a non-contact manner using a charge roller;
a development unit that develops the electrostatic latent images on the image carrying member with a developer transported by a development roller;
a transfer unit that transfers the developer images on the image carrying member onto a transfer medium;
a cleaning unit that removes a transfer-residual developer remaining on the image carrying medium after the developer images are transferred onto the transfer medium, using a cleaning blade making contact with the image carrying member;
a first gap member having electrical insulation properties that is fixed onto one end of the charge roller and pressed onto an outer peripheral surface of the image carrying member, thereby forming a charging gap; and
a second gap member having electrical insulation properties that is fixed onto the other end of the charge roller and pressed onto an outer peripheral surface of the image carrying member, thereby forming a charging gap,
wherein discharge dead zones are disposed between the inner edges of the first and second gap members and both ends of a developer-developing area on the development roller,
wherein the cleaning blade is disposed such that the ends of the cleaning blade are positioned outside of the inner edges of the first and second gap members, and
wherein axial lengths between the ends of the cleaning blade and corresponding inner edges of the first and second gap members are set so as to be larger than axial lengths of the discharge dead zones.
